(19) United States
(12) Patent Application Publication
(10) Pub. No.: US 2011/0206963 A1
(43) Pub. Date: Aug. 25, 2011

(54) INORGANIC OXIDE POWDER AND INORGANIC OXIDE-CONTAINING SLURRY, AND LITHIUM ION SECONDARY BATTERY USING THE SAME SLURRY AND METHOD OF PRODUCING THE SAME

(75) Inventors: Noriaki FUJITA, Niihama-shi (JP); Shinji FUJIWARA, Niihama-shi (JP)

(73) Assignee: SUMITOMO CHEMICAL COMPANY, LIMITED, Tokyo (JP)

(21) Appl. No.: 13/033,041

(22) Filed: Feb. 23, 2011

(30) Foreign Application Priority Data
Feb. 25, 2010 (JP) P 2010-040917
May 20, 2010 (JP) P 2010-116516

(51) Int. Cl. H01M 10/36; H01M 10/04; H01M 10/0587; B32B 3/26

(52) U.S. Cl. 429/94; 29/623.3; 29/623.5; 428/304.4

(57) ABSTRACT

An inorganic oxide powder suited to form an inorganic oxide porous film having insulating properties on a surface of at least one of a positive electrode, a negative electrode and a separator which are used configure a lithium ion secondary battery is provided. Disclosed is an inorganic oxide powder used to form an inorganic oxide porous film having insulating properties on a surface of at least one of a positive electrode, a negative electrode and a separator used in a lithium ion secondary battery, wherein

(1) oxide purity is 90% by weight or more,

(2) the content of coarse particles having a particle diameter of 10 μm or more is 10 ppm or less in terms of a mass ratio, and

(3) porosity of a green formed body of the inorganic oxide powder prepared under a pressure within a range of 29 MPa or more and 147 MPa or less is 40% by volume or more and 80% by volume or less, an average pore diameter of the green formed body is 0.06 μm or more, and an amount of a change in porosity per pressure of 1 MPa at the time of molding of the green formed body is 0.020% or more and 0.060% or less.

### BACKGROUND OF THE INVENTION

1. Field of the Invention

The present invention relates to an inorganic oxide powder used to form an inorganic oxide porous film having insulating properties on a surface of at least one of a positive electrode, a negative electrode and a separator which is used in a lithium ion secondary battery. The present invention also relates to a slurry containing this inorganic oxide powder and even to a lithium ion secondary battery using this slurry, and a method of producing the same.

2. Description of the Related Art

Because of its high energy density, a lithium ion secondary battery is used in portable digital devices such as cellular phones and personal computers, and the lithium ion secondary battery for automotive applications, in addition to these digital devices, has recently been accelerated.

Commonly, the lithium ion secondary battery includes a positive electrode and a negative electrode, and also includes a separator disposed for the purpose of electrically insulating the space between these electrode sheets. As the separator for a lithium ion secondary battery, for example, a microporous sheet made of a polyolefinic resin is used.

In case short circuit occurs inside a battery, clogging of pores of the separator is caused by a shutdown function of the separator and it becomes impossible to move lithium ions of the portion where the short circuit occurs, and thus a battery function of the short circuit site is lost. In such a manner, the separator composed of the microporous sheet takes a role of maintaining safety of a lithium ion secondary battery. However, when the temperature of the battery is, for example, higher than 150° C. as a result of heat generated momentarily, the separator undergoes rapid shrinkage, and thus the short circuit site of the positive electrode and the negative electrode may be sometimes enlarged. In this case, the temperature of the battery sometimes reach a state of being abnormally overheated to several hundred degrees or higher, resulting in a problem in safety.

Therefore, JP H09-147916A proposes, as means for solving the above problems, a technology in which an inorganic oxide porous film containing an inorganic oxide filler having insulating properties is formed on an electrode (e.g., on a surface of a positive electrode, a negative electrode or a separator which constitutes a lithium ion secondary battery).

Also, JP 2005-327680A discloses a lithium ion secondary battery including a porous film having a thickness of 2 to 10 μm and porosity of 35 to 75% by volume using, as an inorganic oxide filler used in such an inorganic oxide porous film, α alumina particles having heat resistance in a state where primary particles having an average particle diameter of 0.2 to 1.5 μm are connected. The same document describes that use of such α alumina particles is suited to control a pore structure of a porous film.

Also, International Publication No. WO 2005/124899 pamphlet discloses that it is possible to prevent charge and discharge characteristics at a large current of the battery and charge and discharge characteristics under a low temperature environment from drastically deteriorating by adjusting porosity of a porous film within a range from 40 to 80%, preferably from 45 to 80%, and most preferably from 50 to 70%, and also describes that a alumina particles having a bulk density of 0.1 to 0.8 g/cm³ and a BET specific surface area of 5 to 20 m²/g are preferably used as the inorganic oxide filler used herein, and polycrystal particles obtained by calcining and mechanically grinding an a alumina precursor are preferably used as the α alumina particles.

Furthermore, International Publication No. WO 2008/004430 pamphlet proposes that, although an inorganic oxide porous film containing such an inorganic oxide filler is formed by dispersing an inorganic oxide powder in a solvent, together with additives such as binder and using a coating method such as gravure printing, a coarse aggregate of inorganic oxide is removed since coarse particles in which a size of inorganic oxide filler particles is larger than a film thickness of the objective porous film are often mixed therein.

Also, JP 2008-91192A discloses a method in which a porous film containing such an inorganic oxide filler are obtained by coating a paste containing an inorganic oxide filler, a binder and a solvent, and then drying the paste and rolling into a predetermined thickness.

However, in case an inorganic oxide porous film is formed using the inorganic oxide powder which satisfies a shape, a bulk density, an average particle diameter and a BET specific surface area described in aforementioned patent documents, the objective porosity cannot be achieved and the obtained porous film contains many coarse aggregate particles which cause a problem in the production of a porous film, and thus the powder is not necessarily satisfactory as a powder for formation of an inorganic porous film of a lithium ion secondary battery.

### SUMMARY OF THE INVENTION

Under these circumstances, an object of the present invention is to provide an inorganic oxide powder used to form an inorganic oxide porous film having excellent heat resistance and insulating properties on a surface of at least one of a positive electrode, a negative electrode and a separator which constitutes a lithium ion secondary battery, and an inorganic oxide slurry containing the inorganic oxide powder. Another object of the present invention is to provide a lithium ion secondary battery including an inorganic oxide porous film composed of the inorganic oxide powder, and a method of producing the same.

The present inventors have intensively studied so as to achieve the above objects, and found that the following inventions agree with the above objects, and thus the present invention has been completed.

The present invention provides the following inventions.

<1> An inorganic oxide powder used to form an inorganic oxide porous film having insulating properties on a surface of at least one of a positive electrode, a negative electrode and a separator disposed in a lithium ion secondary battery, wherein

(1) oxide purity is 90% by weight or more,

(2) the content of coarse particles having a particle diameter of 10 μm or more is 10 ppm or less in terms of a mass ratio, and

(3) porosity of a green formed body (or pressure molding) of the inorganic oxide powder obtained under a pressure within a range of 29 MPa or more and 147 MPa or less is 40% by volume or more and 80% by volume or less, an average pore diameter of the green formed body is 0.06 μm or more, and an amount of a change in porosity per pressure of 1 MPa at the time of molding of the green formed body is 0.020% or more and 0.060% or less.

<2> The inorganic oxide powder according to <1>, wherein the inorganic oxide is α alumina.
<3> The inorganic oxide powder according to <2>, wherein a thermal expansion coefficient at 40° C. to 600° C. of the green formed body of the inorganic oxide powder obtained under a pressure of 147 MPa is 7×10⁻⁶/° C. or more and 9×10⁻⁶/° C. or less.
<4> An inorganic oxide slurry comprising the inorganic oxide powder according to any one of <1> to <3>, a binder and a solvent.
<5> A method for producing a lithium ion secondary battery comprising an electrode group obtained by laminating and winding a positive electrode, a negative electrode and a separator, and an electrolytic solution, the method comprising the steps of:

coating the inorganic oxide slurry according to claim 4 on a surface of positive electrode and/or negative electrode composed of an electrode mixture layer containing an electrode active material and a binder, and drying the slurry to form an inorganic oxide porous film.

<6> A method for producing a lithium ion secondary battery comprising an electrode group obtained by laminating and winding a positive electrode, a negative electrode and a separator, and an electrolytic solution, the method comprising the steps of:

coating the inorganic oxide slurry according to <4> on a surface of a separator, and drying the slurry to form an inorganic oxide porous film.

<7> A lithium ion secondary battery which is obtained by the method according to <5> or <6>.

According to the inorganic oxide powder of the present invention, it is possible to provide a thermally stable inorganic oxide porous film which has porosity associated with lithium ionic conductivity best suited for lithium ion secondary battery application, and also has high uniformity.

### DETAILED DESCRIPTION OF THE INVENTION

The present invention provides an inorganic oxide powder (hereinafter sometimes referred to as an “inorganic oxide powder of the present invention”, or sometimes referred simply to as an “inorganic oxide powder”) which is an inorganic oxide powder used to form an inorganic oxide porous film having insulating properties on a surface of at least one of a positive electrode, a negative electrode and a separator which are used to configure a lithium ion secondary battery, wherein

(1) oxide purity is 90% by weight or more,

(2) the content of coarse particles having a particle diameter of 10 μm or more is 10 ppm or less in terms of a mass ratio, and

(3) porosity of a green formed body of the inorganic oxide powder prepared under a pressure within a range of 29 MPa or more and 147 MPa or less is 40% by volume or more and 80% by volume or less, an average pore diameter of the green formed body is 0.06 μm or more, and an amount of a change in porosity per pressure of 1 MPa at the time of molding of the green formed body is 0.020% or more and 0.060% or less.

In the present invention, the change in porosity per pressure of 1 MPa at the time of molding of the green formed body means that a change in the value of the porosity (in terms of percent value) when pressure applied to the green formed body is changed by 1 MPa.

For example, in case that a green formed body is prepared under a pressure of 73 MPa and porosity of the obtained green formed body is 55.8% by volume and another green formed body is prepared under a pressure of 147 MPa and porosity of the obtained another green formed body is 52.2% by volume, the change in porosity per pressure of 1 MPa at the time of molding of the green formed body calculated by using these results is an absolute value of the change in the value of the porosity (i.e. 55.8%−52.2%=3.6%) divided by the change of the pressure at the time of molding of the green formed body (i.e. 73−147=−74) and thus it is 0.049% (i.e. 3.6%/74).

The inorganic oxide powder of the present invention is not particularly limited as long as it is a material having electrical insulating properties, and it is possible to use aluminum oxide, titanium oxide, magnesium oxide, silicon oxide and the like, and preferably aluminum oxide (alumina). Particularly, α alumina, which is excellent in heat resistance and is chemically stable, is most preferred.

Purity of the inorganic oxide powder of the present invention is preferably 90% by weight or more, more preferably 99% by weight or more, still more preferably 99.9% by weight or more, and most preferably 99.99% by weight or more.

Particularly, in case the inorganic oxide powder of the present invention is an α alumina powder and the purity is less than 90% by weight, the content of impurities such as Si, Na and Fe in the α alumina powder increases. Therefore, not only satisfactory electrical insulation properties are not obtained, but also the mix amount of foreign materials made of metal which can cause short circuit increases, unfavorably.

Also, porosity of a green formed body made from the inorganic oxide powder of the present invention under a pressure within a range of 29 MPa or more and 147 MPa or less is 40% by volume or more and 80% by volume or less, and an average pore diameter is 0.06 μm or more. Furthermore, an amount of a change in porosity per 1 MPa of the pressure at the time of molding (or forming) a green formed body of the inorganic oxide powder is 0.020% or more, and preferably 0.025% or more, and the amount of a change in porosity is 0.080% or less, preferably 0.065% or less, and more preferably 0.060% or less.

In the inorganic oxide powder of the present invention, when the pressure at the time of molding a green formed body is 29 MPa or less, a homogeneous green formed body cannot be sometimes made because of low molding pressure. Also, when the pressure at the time of molding a green formed body is 147 MPa or more, a uniform green formed body cannot be sometimes made since cracking is generated at the time of molding.

In case the porosity of the green formed body of the inorganic oxide powder of the present invention is less than 40% by volume, the porosity of an inorganic oxide porous film of the inorganic oxide powder of the present invention obtained by coating a slurry prepared from the inorganic oxide powder on a surface of an electrode mixture layer containing an electrode active material (a positive electrode active material or a negative electrode active material) and a binder, and drying the slurry also decreases and, as a result, the amount of an electrolytic solution contained in the above inorganic oxide porous film decreases, unfavorably.

In case the porosity of the green formed body of the inorganic oxide powder of the present invention is more than 80% by volume, the porosity of an inorganic oxide porous film of the inorganic oxide powder of the present invention obtained by coating a slurry prepared from the inorganic oxide powder of the present invention on a surface of an electrode (a positive electrode or a negative electrode) composed of an electrode mixture layer containing an electrode active material and a binder, and drying the slurry also increases and the strength of the above inorganic oxide porous film decrease, unfavorably. In case the average pore diameter is less than 0.06 μm, the same phenomenon as in case the above green formed body has small porosity occurs, unfavorably.

When an amount of a change in porosity per pressure of 1 MPa at the time of molding of the green formed body of the inorganic oxide powder of the present invention is less than 0.020%, it becomes impossible to control the porosity of an inorganic oxide porous film of the inorganic oxide powder of the present invention obtained by coating a slurry prepared from an inorganic oxide powder of the present invention on a surface of an electrode (a positive electrode or a negative electrode) composed of an electrode mixture layer containing an electrode active material and a binder, and drying the slurry, unfavorably. On the other hand, when an amount of a change in porosity per pressure of 1 MPa at the time of molding of the green formed body of the inorganic oxide powder of the present invention is more than 0.060%, the porosity in an inorganic oxide porous film of the inorganic oxide powder of the present invention obtained by coating a slurry prepared from an inorganic oxide powder of the present invention on a surface of an electrode (a positive electrode or a negative electrode) composed of an electrode mixture layer containing an electrode active material and a binder, and drying the slurry, becomes non-uniform, thus making it impossible to uniformly maintain an electrolytic solution, unfavorably.

Also, in the inorganic oxide powder of the present invention, the content of coarse particles having a particle diameter of 10 μm or more is 10 ppm or less in terms of a mass ratio. In case the content of coarse particles having a particle diameter of 10 μm or more is more than 10 ppm, defects such as stripe, or coarse pores due to aggregate particles maybe sometimes formed partially on the coating film.

As described above, α alumina is preferred as the inorganic oxide powder of the present invention. In case the inorganic oxide powder of the present invention is α alumina, when an α alumina powder, a binder and a solvent are mixed to prepare an α alumina slurry and the obtained α alumina slurry is coated on a surface of an electrode mixture layer containing an electrode active material to form a coating film, and then the coating film is more preferably subjected to a rolling treatment, it is possible to sufficiently ensure the porosity of an α alumina porous film involved in lithium ionic conductivity and pore diameter and, at the same time, it becomes possible to optionally control porosity within a preferred range, favorably.

Also, in case the inorganic oxide powder of the present invention is α alumina, a thermal expansion coefficient at a temperature of 40° C. to 600° C. of a green formed body prepared under 147 MPa of an α alumina powder is preferably 7×10⁻⁶/° C. or more and 9×10⁻⁶/° C. or less.

Although the inorganic oxide porous film of the lithium ion secondary battery is required to have excellent heat resistance, it is known that a thermal expansion coefficient of α alumina itself is about 8×10⁻⁶/° C. (see, for example, “Introduction To Ceramics”, p 595, Wiley Interscience). It is necessary that the α alumina in the lithium ion secondary battery takes a role of maintaining a stable state even incase short circuit is generated, resulting in an excessively overheated state.

In case the thermal expansion coefficient at a temperature of 40° C. to 600° C. of a green formed body prepared at the pressure of 147 MPa of an a alumina powder is less than 7×10⁻⁶/° C., since particles which forma green formed body causes rearrangement and sintering easily proceeds. Therefore, in case the green formed body is used in an inorganic oxide porous film, physical properties (porosity, etc.) of the film itself may sometimes vary, unfavorably.

In case the thermal expansion coefficient is more than 9×10⁻⁶/° C., mismatching between the thermal expansion coefficient of a positive electrode and that of a negative electrode increases. In case the green formed body is used in an inorganic oxide porous film, cracking may sometimes generate in the inorganic oxide porous film, unfavorably.

The α alumina powder, which is preferred as the inorganic oxide powder of the present invention, has an average particle diameter (average aggregate particle diameter) of 1 μm or less, and has a BET specific surface area of 1 to 20 m² /g, and preferably 2 to 15 m²/g.

The method of producing an a alumina powder of the present invention is not particularly limited and, for example, the α alumina powder can be produced by an aluminum alkoxide method.

The aluminum alkoxide method refers to a method in which an aluminum alkoxide is hydrolyzed to obtain a slurry-, sol- or gel-like aluminum hydroxide, followed by drying to obtain a dry-powdered aluminum hydroxide.

Specifically describing, the aluminum alkoxide includes compounds represented by the following formula (1):

Al (OR¹) (OR²) (OR³) (1)

wherein R¹, R² and R³ each independently represents an alkyl group.

Examples of the alkyl group in the formula (1) include alkyl groups having 1 to 4 carbon atoms, such as a methyl group, an ethyl group, an n-propyl group, an iso-propyl group, an n-butyl group, an iso-butyl group, a sec-butyl group and a tert-butyl group. Specific examples of the aluminum alkoxide include aluminum isopropoxide, aluminum ethoxide, aluminum sec-butoxide and aluminum tert-butoxide.

The slurry-like aluminum hydroxide obtained by hydrolyzing the aluminum alkoxide with water usually has an average primary particle diameter within a range from 0.01 to 1 μm, and preferably from 0.02 to 0.05 μm.

The powdered aluminum hydroxide obtained by drying the slurry-like aluminum hydroxide is in the form of a bulky powder having usually untamped density within a range from about 0.1 to 0.8 g/cm³. The untamped density is preferably from 0.4 to 0.8 g/cm³ .

The objective α alumina can be obtained by calcining the above dry-powdered aluminum hydroxide. Calcining is usually carried out in a state of being filled into a calcining container. The calcining container includes, for example, a square crucible. The calcining container is preferably made of the material such as alumina from the viewpoint of pollution control.

Examples of the calcining furnace used in calcining include material stationary type furnaces typified by a tunnel kiln, a batch aeration-type flow box type calcining furnace, a batch co-flow box type calcining furnace and the like. A rotary kiln is also exemplified.

The calcination temperature, the temperature raising rate until the temperature reaches the calcination temperature, and the calcining time are appropriately selected so as to obtain α alumina having the intended physical properties described above. The calcination temperature is from 1,100 to 1,450° C., and preferably from 1,200 to 1,350° C., the temperature raising rate until the temperature reaches the calcination temperature is usually from 30 to 500° C./hour, and the calcining time is usually from 0.5 to 24 hours, and preferably from 1 to 10 hours.

The calcining atmosphere may be, in addition to atmospheric air, an inert gas such as a nitrogen gas or an argon gas. Calcining may be carried out in an atmosphere having a high partial water vapor pressure like a gas furnace in which calcining is carried out by combustion using a propane gas or the like.

The obtained α alumina powder is preferably ground since it is aggregated in a state where an average particle diameter is more than 1 μm in some cases. The grinding method is not particularly limited and can be carried out, for example, using known devices such as a vibrating mill, a ball mill and a jet mill. It is also possible to employ any of dry and wet grinding methods. As a method of grinding while maintaining purity without including coarse aggregate particles, a method of grinding using a jet mill can be exemplified as a preferred method.

The inorganic oxide slurry of the present invention is composed of the above inorganic oxide powder of the present invention, a binder and a solvent.

Known binders can be used as the binder and, specifically, it is possible to use fluorine resins such as polyvinylidene fluoride (PVDF), polytetrafluoroethylene (PTFE) and a tetrafluoroethylene-hexafluoropropylene copolymer (FEP); polyacrylic acid derivatives such as polyacrylic acid, a polymethyl acrylate ester, a polyethyl acrylate ester, a polyacrylic acid hexyl ester and a polyacrylic acid hexyl ester; polymethacrylic acid derivatives such as polymethacrylic acid, a polymethyl methacrylate ester, a polyethyl methacrylate ester and a polymethacrylic acid hexyl ester; polyamide, polyimide, polyamideimide, vinyl polyacetate, polyvinylpyrrolidone, polyether, polyethersulfone, hexafluoropolypropylene, a styrene-butadiene rubber, carboxymethyl cellulose, polyacrylonitrile and derivatives thereof, polyethylene, polypropylene, an aramid resin and the like.

A copolymer of two or more kinds of materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid and hexadiene may be used.

Known solvents can be used as the solvent and, specifically, water, acetone, tetrahydrofuran, methylene chloride, chloroform, dimethylformamide, N-methyl-2-pyrrolidone (NMP), cyclohexane, xylene, cyclohexanone or a mixed solvent thereof can be used.

Known thickeners may be added so as to obtain an inorganic oxide slurry having viscosity best suited for coating.

The method of dispersing the above inorganic oxide slurry is not particularly limited, and a stirring method by a known planetary mixer and a method of dispersing by irradiation with ultrasonic wave can be used. At this time, as the viscosity at a shear rate of 100 S⁻¹ of the slurry decreases, workability of dispersion, mixing and transfer steps becomes satisfactory.

Also, the method of coating the above inorganic oxide slurry onto a surface of a positive electrode or an electrode mixture layer containing a negative active material and a binder, or a surface of a separator is not particularly limited and, for example, a known doctor blade method, gravure printing method and the like can be used. Also, the drying method is not particularly limited, and a known hot-air drying, vacuum drying and the like can be used. The thickness of the inorganic oxide porous film obtained in that case is preferably set within a range from 1 to 50 μm, and more preferably from about 2 to 10 μm.

The thus obtained inorganic oxide porous film produced from the inorganic oxide slurry has high heat resistance and insulating properties. This inorganic oxide porous film is formed on a surface of at least one of a positive electrode, a negative electrode and a separator, and then laminated and wound together with the positive electrode, the negative electrode and the separator to form an electrode group. As a result, the obtained lithium ion secondary battery including this electrode group and an electrolytic solution is preferably used.

Examples of the method of preferably producing such a lithium ion secondary battery include a method including the step of coating the above inorganic oxide slurry on a surface of a positive electrode and/or a negative electrode composed of an electrode mixture layer containing an electrode active material (a positive-electrode active material or a negative-electrode active material) and binder, followed by drying to form an inorganic oxide porous film. Also, the method may be a method of coating the above inorganic oxide slurry on a surface of a separator, not on a surface of a positive electrode and/or a negative electrode, followed by drying to form an inorganic oxide porous film.

Specific method is exemplified as follows. That is, one end of a negative electrode lead is joined to a negative electrode lead joint portion in which an inorganic oxide porous film is formed on a surface, and one end of a negative electrode is joined to a positive electrode lead joint portion, and a positive electrode and a negative electrode are laminated and wound via a separator to form an electrode group (electrode sheet group). This electrode group (electrode sheet group) is accommodated in a battery can in a state of being interposed between upper and lower insulating rings and, after injecting an electrolytic solution, the battery can is closed by a battery lid, and thus a lithium ion secondary battery having excellent safety can be produced.

In case the above lithium ion secondary battery (including an inorganic oxide porous film) is produced, the above inorganic oxide porous film may be produced by the steps of coating an inorganic oxide slurry of the present invention on a surface of a separator and drying the slurry.

The lithium ion secondary battery produced by the above method includes an inorganic oxide porous film formed from the inorganic oxide powder of the present invention and is therefore has excellent heat resistance and insulating properties.

### EXAMPLES

The present invention will be described in detail by way of Examples, but the present invention is not limited only to the following Examples. The methods for evaluation of the respective physical properties are as follows.

### (Alumina Purity)

The contents of Si, Na, Mg, Cu, and Fe were measured by a solid-state emission spectroscopy.

Alumina purity was determined by subtracting sum total (%) of the weights of Si, Na, Mg, Cu and Fe contained in α alumina from 100. The calculation formula is as follows.

Purity (%)=100−sum total (%) of weights of impurities

### (BET Specific Surface Area)

In accordance with the method defined in JIS-Z-8830, a BET specific surface area was determined by a nitrogen absorption method. As an apparatus for the measurement of a specific surface area, “FlowSorb II 2300” manufactured by Shimadzu Corporation was used.

### (Average Secondary Particle Diameter)

Using a particle size distribution analyzer utilizing a laser scattering method as basic principles (“Microtrack HRA X-100”, manufactured by Honeywell Inc.), a particle size distribution curve was determined and an average secondary particle diameter was measured as a 50 wt %-equivalent particle diameter. In the case of the measurement, ultrasonic dispersion was carried out using an aqueous 0.2% by weight sodium hexametaphosphate solution.

### (Porosity of Green Formed Body)

A mold having a diameter of 30 mm was filled with 10 g of an α alumina powder and subjected to uniaxial molding (uniaxial pressing) under a pressure of 29 MPa, followed by CIP molding under a pressure of 29, 73 or 147 MPa to obtain green formed bodies, and then a pore volume and a pore diameter were measured using Mercury Porosimeter (AutoPore III9430, manufactured by Micromeritics Instrument Corporation). Porosity of each green formed body was obtained by the following equation.

Porosity (% by volume)=[pore volume (ml/g)/((1/3.98*)+pore volume (ml/g))]×100

*3.98=theoretical density (g/cm³) of α alumina

Furthermore, porosity dependency of a molding pressure was calculated by a relation between the pressure and the porosity using a least square method.

### (Thermal Expansion Coefficient)

A green formed body having a diameter of 10 mm was filled with 1.5 g of an α alumina powder and subjected to uniaxial molding at room temperature under a pressure of 49 MPa, followed by CIP molding under a pressure of 147 MPa to obtain green formed bodies, and then a thermal expansion coefficient was measured by Thermo Mechanical Analyzer (TMA/SS6300, manufactured by SII NanoTechnology Inc.). Regarding the thermal expansion coefficient, an expansion coefficient up to 600° C. was subjected to linear approximation and then defined as a gradient of the approximation straight line.

### (Content of Coarse Aggregate Particles of 10 mm or More)

An α alumina powder (1.5 to 30 g) was dispersed in 800 g of pure water containing 0.2% of sodium hexametaphosphate as a dispersing agent by irradiating with ultrasonic wave to prepare an α alumina slurry and the slurry was passed through a sieve having a pore diameter of 10 μm, and then the α alumina powder remained on the sieve was recovered and the content was measured.

### Example 1

First, aluminum isopropoxide prepared from aluminum having purity of 99.99% as a raw material was hydrolyzed with water to obtain a slurry-like aluminum hydroxide, which was dried to obtain a dry-powdered aluminum hydroxide having untamped density of 0.1 g/cm³.

Furthermore, this dry-powdered aluminum hydroxide was calcined by maintaining in a gas furnace capable of calcining by combustion of a propane gas at 1,200° C. for 3 hours, and then ground by a jet mill to obtain an α alumina powder.

The obtained a alumina powder had a BET specific surface area of 5.2 m²/g, an average particle diameter of 0.45 μm, and the content of coarse particles having a particle diameter of 10 μm or more of 3 ppm or less . Regarding the content of impurities, the content of Si was 4 ppm, the content of Fe was 7 ppm, the content of Cu was 1 ppm, the content of Na was 2 ppm, the content of Mg was 1 ppm, and alumina purity was 99.99% by weight or more.

Furthermore, the obtained a alumina powder was subjected to molding to obtain green formed bodies under a pressure of 29, 73 and 147 MPa. Porosities of each green formed body were 59.2, 55.8 and 52.2% by volume, respectively, an average pore diameter was within a range from 0.08 to 0.11 μm, a change in porosity per 1 MPa was 0.059%, and a thermal expansion coefficient of the green formed body at 40° C. to 600° C. was 8.5×10⁻⁶/° C.

The α alumina powder obtained as described above, a polyvinylidene fluoride (PVDF) as a film binder, and an appropriate amount of N-methyl-2-pyrrolidone (NMP) as a solvent were mixed and stirred to prepare a porous coating paste (slurry) in which the content of a filler accounts for 94% by weight of the total amount of the filler and the film binder. The viscosity of the slurry was measured by a viscoelasticity analyzer (Physica MCR301, manufactured by Anton Paar). As a result, it was 0.32 Pa·s when a shear rate is 100 S⁻¹.

On a top surface of a sheet-like electrode made by coating a natural spherical graphite on a copper sheet, this porous coating paste was coated by a bar coater and then dried to obtain a homogeneous porous film having a thickness of 3 to 5 μm.

### Example 2

Aluminum isopropoxide prepared from aluminum having purity of 99.99% as a raw material was hydrolyzed with water to obtain a slurry-like aluminum hydroxide, which was dried to obtain a first dry-powdered aluminum hydroxide. Next, this first dry-powdered aluminum hydroxide was wetted with pure water and dried to obtain a dry-powdered aluminum hydroxide having untamped density of 0.6 g/cm³.

Furthermore, this dry-powdered aluminum hydroxide was calcined by maintaining at 1,220° C. for 4 hours, and then ground by a jet mill to obtain an α alumina powder.

The obtained α alumina powder had a BET specific surface area of 4.13 m²/g, an average particle diameter of 0.69 μm, and the content of coarse particles having a particle diameter of 10 μm or more of 3 ppm or more. However, the content of coarse particles did not reach 10 ppm. Regarding the content of impurities, the content of Si was 11 ppm, the content of Fe was 10 ppm, the content of Cu was 1 ppm or less, the content of Na was 5 ppm or less, the content of Mg was 1 ppm or less, and alumina purity was 99.99% by weight or more.

Furthermore, the obtained a alumina powder was subjected to molding to obtain green formed bodies under a pressure of 29, 73 and 147 MPa. Porosities of each green formed body were 53.7, 52.0 and 50.5% by volume, respectively, an average pore diameter was within a range from 0.12 to 0.13 μm, a change in porosity per 1 MPa was 0.027%, and a thermal expansion coefficient of the green formed body at 40° C. to 600° C. was 8.7×10⁻⁶/° C.

In the same manner as in Example 1, except that an aluminum alkoxide prepared from aluminum having purity of 99.9% as a raw material was used, an α alumina powder was obtained.

The α alumina powder obtained as described above, a polyvinylidene fluoride (PVDF) as a film binder, and an appropriate amount of N-methyl-2-pyrrolidone (NMP) as a solvent were mixed and stirred to prepare a porous coating paste (slurry) in which the content of a filler accounts for 94% by weight of the total amount of the filler and the film binder. The viscosity of the slurry was measured by a viscoelasticity analyzer (Physica MCR301, manufactured by Anton Paar). As a result, it was 0.19 Pa·s when a shear rate is 100 S⁻¹.

On a top surface of a sheet-like electrode made by coating a natural spherical graphite on a copper sheet, this porous coating paste was coated by a bar coater and then dried to obtain a homogeneous microporous film having a thickness of 3 to 5 μm.

The sheet-like electrode obtained by the above method was cut into a cycle having a diameter of 1.45 cm to make an electrode, and the obtained electrode was vacuum-dried at 120° C. for 8 hours. After vacuum drying, using the obtained electrode as a negative electrode, a lithium foil as a positive electrode, TF40-50 manufactured by NIPPON KODOSHI CORPORATION as a separator, and LiPF₆/ethylene carbonate:dimethyl carbonate:ethylmethyl carbonate having a concentration of 1 mol/liter (=20:30:30 v/v %) +3 wt % vinylene carbonate as an electrolytic solution, respectively, a bipolar cell was assembled by using CR2032 type (IEC/JIS standard) coin cell, and then a capacity retention ratio 1C/0.2C was calculated. As a result, it was 99%.

Here, a capacity retention ratio 1C/0.2 in the present invention was calculated as follows. Using a charging and discharging evaluation device (“TOSCAT(registered trade mark)-3100”, manufactured by Toyo System Co., Ltd.), constant-current charging was carried out at a current density 60 mA/g until the bipolar cell reached 5 mV. After reaching 5 mV, a constant-potential charging was carried out until a current value becomes 6 mA/g, and then a discharging was carried out at a constant current of current density of 60 mA/g until reaching 1.5 V. In the second cycle, the same charging and discharging were carried out and an integrated quantity of electricity at the time of discharging in the second cycle was taken as a capacity at the time of 0.2C. Subsequently, the third cycle was carried out and a constant current charging was carried out at a current density of 60 mA/g until reaching 5 mV. After reaching 5 mV, a constant-potential charging was carried out until a current value reaches 6 mA/g. Then, a discharging was carried out at a constant current of a current density of 360 mA/g until reaching 1.5 V. In the fourth cycle, the same charging and discharging were carried out and an integrated quantity of electricity at the time of discharging in the fourth cycle was taken as a capacity at the time of 1C. The value obtained by multiplying the value, which is obtained by dividing the obtained capacity at the time of 1C by the capacity at the time of 0.2C, and 100 was taken as a capacity retention ratio 1C/0.2C.

### Comparative Example 1

First, in the same manner as in Example 1, a dry-powdered aluminum hydroxide was obtained. Furthermore, this aluminum hydroxide was calcined by maintaining at 1,250° C. for 2 hours, and then ground by a vibrating mill to obtain an α alumina powder.

The obtained α alumina powder had a BET specific surface area of 11.0 m²/g, an average particle diameter of 0.22 μm, and the content of coarse particles having a particle diameter of 10 μm or more of 7,300 ppm or more. Regarding the content of impurities, the content of Si was 12 ppm, the content of Fe was 3 ppm, the content of Cu was 1 ppm, the content of Na was 2 ppm, the content of Mg was 1 ppm, and alumina purity was 99.99% by weight or more.

Furthermore, the obtained a alumina powder was subjected to molding to obtain green formed bodies under a pressure of 29, 73 and 147 MPa. Porosities of each green formed body were 46.3, 44.5 and 43.7% by volume, respectively, an average pore diameter was about 0.04 μm, a change in porosity per 1 MPa was 0.020%, and a thermal expansion coefficient of the green formed body at 40° C. to 600° C. was 6.1×10⁻⁶/° C.

The α alumina powder obtained as described above, a polyvinylidene fluoride (PVDF) as a film binder, and an appropriate amount of N-methyl-2-pyrrolidone (NMP) as a solvent were mixed and stirred to prepare a porous coating paste (slurry) in which the content of a filler accounts for 94% by weight of the total amount of the filler and the film binder. The viscosity of the slurry was measured by a viscoelasticity analyzer (Physica MCR301, manufactured by Anton Paar). As a result, it was 0.15 Pa·s when a shear rate is 100 S⁻¹.

On a top surface of a sheet-like electrode made by coating a natural spherical graphite on a copper sheet, this porous coating paste was coated by a bar coater and then dried As a result, coating film unevenness, which is considered to be caused by aggregate particles, occurred and a homogeneous coating film was not obtained.

### Comparative Example 2

First, in the same manner as in Example 1, a dry-powdered aluminum hydroxide was obtained. Furthermore, this aluminum hydroxide was calcined by maintaining at 1,270° C. for 4 hours, and then ground by a vibrating mill to obtain an α alumina powder.

The obtained a alumina powder had a BET specific surface area of 5.1 m²/g, an average particle diameter of 0.52 μm, and the content of coarse particles having a particle diameter of 10 μm or more of 800 ppm or more. Regarding the content of impurities, the content of Si was 15 ppm, the content of Fe was 7 ppm, the content of Cu was 1 ppm, the content of Na was 4 ppm, the content of Mg was 3 ppm, and alumina purity was 99.99% by weight or more.

Furthermore, the obtained α alumina powder was subjected to molding to obtain green formed bodies under a pressure of 29, 73 and 147 MPa. Porosities of each green formed bodies were 42.9, 42.6 and 41.5% by volume, respectively, an average pore diameter was about 0.09 μm, a change in porosity per 1 MPa was 0.012%, and a thermal expansion coefficient of the green formed body at 40° C. to 600° C. was 8.1×10⁻⁶/° C.

The α alumina powder obtained as described above, a polyvinylidene fluoride (PVDF) as a film binder, and an appropriate amount of N-methyl-2-pyrrolidone (NMP) as a solvent were mixed and stirred to prepare a porous coating paste (slurry) in which the content of a filler accounts for 94% by weight of the total amount of the filler and the film binder. The viscosity of the slurry was measured by a viscoelasticity analyzer (Physica MCR301, manufactured by Anton Paar). As a result, it was 0.11 Pa·s when a shear rate is 100 S⁻¹.

On a top surface of a sheet-like electrode made by coating a natural spherical graphite on a copper sheet, this porous coating paste was coated by a bar coater and then dried As a result, coating film unevenness, which is considered to be caused by aggregate particles, occurred and a homogeneous coating film was not obtained.

The inorganic oxide powder of the present invention can provide an inorganic oxide porous film which has optimum porosity associated with lithium ionic conductivity best suited for lithium ion secondary battery application, and also has high uniformity and is thermally stable, and is therefore industrially useful.

This application claims priority on Japanese Patent

Application No. 2010-040917 and Japanese Patent Application No. 2010-116516. The disclosure of Japanese Patent Application No. 2010-040917 and Japanese Patent Application No. 2010-116516 is incorporated by reference herein.

1. An inorganic oxide powder used to form an inorganic oxide porous film having insulating properties on a surface of at least one of a positive electrode, a negative electrode and a separator used in a lithium ion secondary battery, wherein
(1) oxide purity being 90% by weight or more,
(2) the content of coarse particles having a particle diameter of 10 μm or more being 10 ppm or less in terms of a mass ratio, and
(3) porosity of a green formed body of the inorganic oxide powder prepared under a pressure within a range of 29 MPa or more and 147 MPa or less being 40% by volume or more and 80% by volume or less, an average pore diameter of the green formed body being 0.06 μm or more, an amount of a change in porosity per pressure of 1 MPa at the time of molding of the green formed body being 0.020% or more and 0.060% or less.

2. The inorganic oxide powder according to claim 1, wherein the inorganic oxide is α alumina.

3. The inorganic oxide powder according to claim 2, wherein a thermal expansion coefficient at 40° C. to 600° C. of the green formed body of the inorganic oxide powder made under a pressure of 147 MPa is 7×10⁻⁶/° C. or more and 9×10⁻⁶/° C. or less.

4. An inorganic oxide slurry comprising the inorganic oxide powder according to claim 1, a binder and a solvent.

5. A method for producing a lithium ion secondary battery comprising an electrode group obtained by laminating and winding a positive electrode, a negative electrode and a separator, and an electrolytic solution, the method comprising the steps of:
coating the inorganic oxide slurry according to claim 4 on a surface of positive electrode and/or negative electrode composed of an electrode mixture layer containing an electrode active material and a binder; and
drying the slurry to form an inorganic oxide porous film.

6. A method for producing a lithium ion secondary battery comprising an electrode group obtained by laminating and winding a positive electrode, a negative electrode and a separator, and an electrolytic solution, the method comprising the steps of:
coating the inorganic oxide slurry according to claim 4 on a surface of a separator; and
drying the slurry to form an inorganic oxide porous film.

7. A lithium ion secondary battery obtained by the method according to claim 5.
